(19) United States
(12) Patent Application Publication
(10) Pub. No.: US 2025/0214231 A1
(43) Pub. Date: Jul. 3, 2025

(54) Computer-Implemented Method and System for Mediating a Robot-Centric Data Schema to a Building-Centric Data Schema

(71) Applicant: The University of Hong Kong, Hong Kong (HK)

(72) Inventors: Junjie CHEN, Hong Kong (HK); Wilson Wei Sheng LU, Hong Kong (HK); Yonglin FU, Hong Kong (HK)

(21) Appl. No.: 18/985,044

(22) Filed: Dec. 18, 2024

Related U.S. Application Data
(60) Provisional application No. 63/615,763, filed on Dec. 28, 2023.

(51) Int. Cl. B25J 9/16; G06F 40/205

(52) U.S. Cl. CPC B25J 9/1605; G06F 40/205

(57) ABSTRACT

The invention provides computer-implemented method and system for mediating a robot-centric data schema to a building-centric data schema for representing a robot is provided. The building-centric data schema represents the robot with a plurality links representing non-deformable parts of the robot and a plurality of joints describing relationship between the links. The method comprises: extracting robot information from the robot-centric data schema; creating a robot container to model the robot as a whole-part structure; translating the plurality of links and the plurality of joints from the robot-centric data schema to the building-centric data schema based on the extracted robot information; filling the robot container with the translated links and translated joints; and constructing the building-centric data schema with the robot container filled with the translated links and translated joints.

### CROSS-REFERENCE TO RELATED APPLICATIONS

The present application claims priority from the U.S. Provisional Patent Application No. 63/615,763 filed 28 Dec., 2023, and the disclosure of which is incorporated herein by reference in its entirety.

### FIELD OF THE INVENTION

The invention generally relates to the fields of schema mediation technique, and specifically relates to computer-implemented method and system for mediating a robot-centric data schema to a building-centric data schema for digitally representing a robot.

### BACKGROUND OF THE INVENTION

Robotics is poised to enhance the productivity of the building industry by replacing humans in hazardous, repetitive, and physically demanding construction tasks. Although its potential had been well-recognized, large-scale construction robotization has only recently become feasible. This progress has been made possible through the collective advancements in various technologies, including artificial intelligence (AI), smart sensing, cybernetics, and others. Preliminary evidence has demonstrated the effectiveness of construction robotics in addressing the long-standing issues of low productivity, inadequate safety management, and inconsistent quality control within the industry. The traditional construction methodology is predicted to soon reach its limits, making way for the widespread adoption of robots in the built environment.

Digital robot representation (DRR) is the key to robot development and its adoption in construction and beyond. It can enable virtual testing of different robot configurations and their fitness with external environment without a need of physically building them. It is conducive to the exchange, reuse, and communication of critical robot information for cross-party and multi-disciplinary coordination. The most prevalent DRR methods are based on the Unified Robot Description Format (URDF). The URDF schema lays out a concise framework to digitally represent a robot's composition, geometry, and properties in terms of kinematics and dynamics. It offers useful abstraction of robots from a robotics engineering perspective, and reduce the cost and resources for robot development.

However, existing URDF-based DRRs are not readily compatible with the established tools and business process of the Architecture, Engineering, Construction and Operation (AECO) sector. From a business perspective, the goal of AECO activities is to conceptualize, materialize, and maintain the built environment, whereas the inherent goal of robotics is to design and develop automated systems that can operate independently. These divergent business goals have led to different expectations for DRRs. The inward focus of robotics has made existing DRRs prioritize information such as robot kinematics, dynamics, and contact interaction simulations, whereas AECO professionals are more concerned with the implications of robot integration on project productivity, cost, and space design. From an implementation perspective, data schemas used in the robotics and AECO sectors diverge significantly. Despite the popularity of URDF in robotics, few building design and project management software solutions support its parsing. Instead, the AECO business workflow nowadays is largely based on Building Information Modelling (BIM), which adopts industry foundation classes (IFC) as its underpinning data schemas. The language barrier between the two sectors of robotics and AECO calls for a schema mediation method to translate URDF to IFC.

### SUMMARY OF THE INVENTION

It is an objective of the present invention to provide a data schema mediation method to solve the aforementioned technical problems.

In accordance with a first aspect of the present invention, a computer-implemented method for mediating a robot-centric data schema to a building-centric data schema for representing a robot is provided. The robot-centric data schema represents the robot with a plurality links representing non-deformable parts of the robot and a plurality of joints describing relationship between the links. The method comprises: extracting robot information from the robot-centric data schema; creating a robot container to model the robot as a whole-part structure; translating the plurality of links and the plurality of joints from the robot-centric data schema to the building-centric data schema based on the extracted robot information; filling the robot container with the translated links and translated joints; and constructing the building-centric data schema with the robot container filled with the translated links and translated joints.

In accordance with a second aspect of the present invention, a computer-implemented system for mediating a robot-centric data schema to a building-centric data schema for representing a robot is provided. The robot-centric data schema represents the robot with a plurality links representing non-deformable parts of the robot and a plurality of joints describing relationship between the links. The system comprises a processor configured to: extract robot information from the robot-centric data schema; create a robot container to model the robot as a whole-part structure; translate the plurality of links and the plurality of joints from the robot-centric data schema to the building-centric data schema based on the extracted robot information; fill the robot container with the translated links and translated joints; and construct the building-centric data schema with the robot container filled with the translated links and translated joints.

### BRIEF DESCRIPTION OF THE DRAWINGS

Embodiments of the invention are described in more details hereinafter with reference to the drawings, in which:

FIG. 1 shows a flowchart for a computer-implemented method for mediating a robot-centric data schema to a building-centric data schema for representing a robot in accordance with an embodiment of the present invention; and

FIG. 2 shows the defined robot representation in the context of the built environment.

FIG. 3 shows how an exemplary robot, TurtleBot, is conceptualized under a fundamental principle of URDF.

FIG. 4 shows the involved IFC entities and how they are connected to form the digital representation of a robot.

FIG. 5 shows an exemplary pseudo code for converting the URDF visual representation of a link to a IFC representation.

FIG. 6 illustrates how a joint's placement is specified by referring to the coordinate frame of its prior joint.

FIG. 7A shows how a tree structure of an IFC representation which has successfully replicated a “whole-part” structure of a robot arm; FIG. 7B shows how a IFC representation visually mimics its physical counterpart from a geometrical and topological standpoint; FIG. 7C shows a close-up view of the Robot Properties in the IFC representation of FIG. 7B; FIG. 7D shows a close-up view of the Link Properties in the IFC representation of FIG. 7B; and FIG. 7E shows a close-up view of the Joint Properties in the IFC representation of FIG. 7B.

FIGS. 8A to 8C show resulting IFC representations for different robot types respectively.

FIG. 9 shows an example of interior space design adaption facilitated by Building RobAvatar.

FIG. 10 shows an example of MEP design by importing IFC robot representation into Revit.

FIG. 11 shows an example of clash detection and instant design adjustment enabled by IFC robot representation.

FIG. 12 shows an IFC Avatar of a TurtleBot adopted in BIM environment to support facility management task.

FIG. 13 shows an exemplary application of digital twin of facility inspection robot based on IFC-substantiated Building RobAvatar and relevant inspection results.

FIG. 14 shows of how to leverage the integration enabled by IFC RoboAvatar to remote control a robot.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

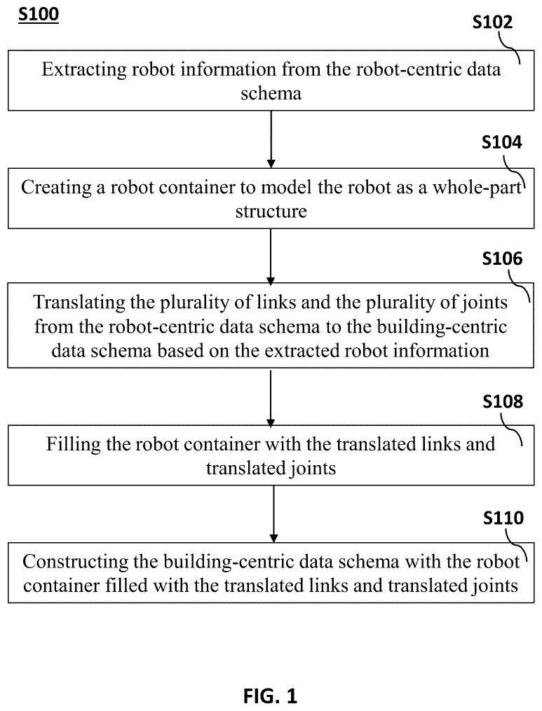

FIG. 1 shows a flowchart for a computer-implemented method for mediating a robot-centric data schema to a building-centric data schema for representing a robot in accordance with an embodiment of the present invention. The robot-centric data schema represents the robot with a plurality links representing non-deformable parts of the robot and a plurality of joints describing relationship between the links. As shown, the method comprising the following steps:
S102: extracting robot information from the robot-centric data schema;
S104: creating a robot container to model the robot as a whole-part structure;
S106: translating the plurality of links and the plurality of joints from the robot-centric data schema to the building-centric data schema based on the extracted robot information;
S108: filling the robot container with the translated links and translated joints; and
S110: constructing the building-centric data schema with the robot container filled with the translated links and translated joints.

In some embodiments, the robot-centric data schema is based on URDF and the building-centric data schema is based on IFC. The computer-implemented method is provided for mediating a URDF file to a IFC file for representing a robot and its Avatar in the context of buildings, with specification and extension from the domain-specific requirements of AECO sector.

The latest authoritative attempt to formalize generic RoboAvatar is the Core Ontology for Robotics and Automation (CORA), which conceives robots as agentive devices composed of other devices. This constructivism view sees a robot as the “sum of the parts”, instead of inseparable whole. CORA adopts a dichotomy to categorize an “Entity” into “Physical” (entity with a location in space-time) and “Abstract” one (entity without a location in space-time). Obviously, a robot and its parts are physical entities, with the former categorized as both “Agent” and “Device”, and the latter as “Device” in CORA. Other than the physical beings, robots manifest a range of properties, which can be described by the “Attribute” under “Abstract” entity. CORA (including its further extension) only defines a few fundamental abstract concepts such as position, orientation, and design. According to the substance-attribute dichotomy, a robot R is the sum of its physical being S and the attributes A it bears, mathematically expressed as:

$$R = \{ S , A \}$$

The purpose of robot representation is to determine a mapping from a physical robot R to its description model F:

ƒⁱ:R→Fⁱ(i∈{ModelView})

Where i refers to a specific model view, defined as the angle or perspective from which the robot is described. From a building perspective, the mapping function ƒ^{b}( ) comprises a substance mapping function ƒ_{S}^{b}( ) and an attribute mapping function ƒ_{A}^{b}( ), as shown below:

$${f}^{b} ( ) = \{ {f}_{S}^{b} ( ) , {f}_{A}^{b} ( ) \} \qquad ( 1 )$$

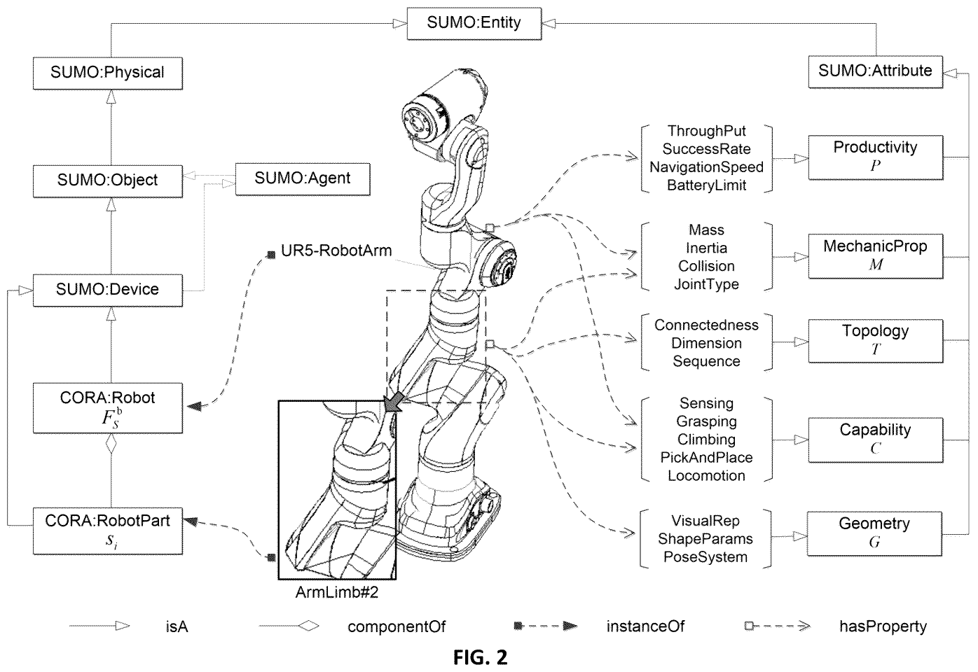

FIG. 2 shows the defined robot representation in the context of built environment, or Building RoboAvatar. Mathematically, the Building RoboAvatar is F^{b}=ƒ^{b}(R), which, similar to the real robot R, is composed of a representation of substance F_{S}^{b} and attributes F_{A}^{b}:

$$\{ \begin{matrix}{F}^{b} = \{ {F}_{S}^{b} , {F}_{A}^{b} \} \\ {F}_{S}^{b} = {f}_{S}^{b} ( S ) \\ {F}_{A}^{b} = {f}_{A}^{b} ( A )\end{matrix} \qquad ( 2 )$$

For substance representation F_{S}^{b}, it should reflect the constructivism nature of robots as being the “sum of the parts”. This will allow kinematic analytics that is a necessity for applications like layout planning and clash detection in AECO sector. The mathematical expression is as follows:

$${F}_{S}^{b} = {f}_{S}^{b} ( S ) = \{ {s}_{i} \vert i ∈ {¥}^{*} , i \leq {N}_{part} \} \qquad ( 3 )$$

Where sᵢ is the substance of a robot part, and Nₚₒᵣₜ is the number of robot parts.

For attribute representation F_{A}^{b}, it should describe both basic geometric and high-level semantic information to meet industrial requirements of the AECO sector. In particular, F_{A}^{b} should comprise a productivity parameter set P, a mechanical property set M, a topology description set T, a capability description set C, and a geometry property set G.

Table 1 summarizes the descriptions, specific indices, working ranges, and the use cases of the attribute sets in built environment.

TABLE 1
Summary of robot description attributes.

| Sets | Attributes ¹ | Descriptions | WR ² | Use cases |
|---|---|---|---|---|
| Productivity | ThroughPut (Pₜₚ) | Through put of a robot in production task | R | Construction |
| (P) | SuccessRate (Pₛᵣ) | Success rate in implementing an action | R | scheduling |
| | NaviSpeed (Pₙₛ) | Speed of navigation in an environment | R | and task |
| | BatteryLimit (P_{bl}) | Upper limit of robot power system | R | planning |
| Mechanical | Mass (Mₘ) | Mass of a robot or its part | B | Path |
| (M) | Inertia (Mᵢ) | Inertia of a robot or its part | B | planning, |
| | Collision (M_{c}) | Range within which will insert collision | B | clearance |
| | Dimension (T_{d}) | Number of robot parts | R | estimation |
| | Joint Type (Mⱼₜ) | Specify relative movement between parts | B | |
| Topology | Connectedness (T_{cn}) | Indicate if two robot parts are connected | P | Kinematic |
| (T) | Sequence (Tₛ) | Order in which the parts are connected | P | analytics, DT |
| Capability | Sensing (Cₛ) | Ability to sense environments | B | Task |
| (C) | Grasping (C_{g}) | Ability to grasp objects | B | assignment |
| | Climbing (C_{c}) | Ability to climb wall, stairs, etc. | B | and work |
| | PickAndPlace (Cₚₚ) | Ability to pick object and place | B | allocation |
| | Locomotion (Cₗ) | Locomotion types, e.g., wheel, leg, etc. | B | |
| Geometry | VisualRep (Gᵥᵣ) | Visual representations (mesh, box, etc.) | P | Visualization |
| (G) | ShapeParams (Gₛₚ) | Length, width, height, centroid, etc. | P | and DT |
| | PoseSystem (Gₚₛ) | Position, orientation and reference frame | P | |

Note:
¹ A unexhausted list of example attributes under particular sets:
² Working range of particular attributes, where R, P, and B denote robot, robot parts, and both.

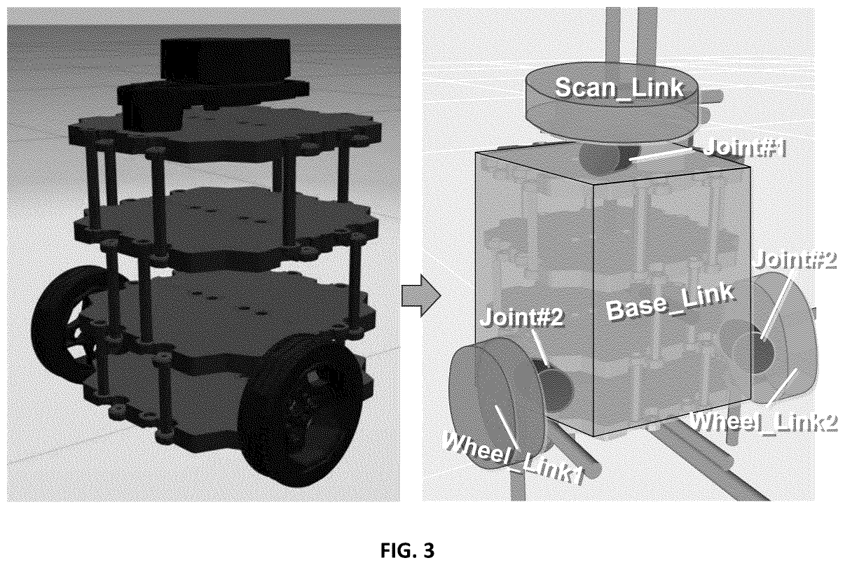

A fundamental principle of URDF is to conceptualize a robot as a combination of links and joints, as exemplified by a TurtleBot in FIG. 3. The links are nondeformable parts of a robot that are connected by joints. The joints represent how two links move relative to each other, which effectively define locations of the links in space. There are six common joint types, that is revolute, continuous, prismatic, fixed, floating, and planar. “fixed” means that all degrees of freedom are locked and the joint cannot move, whereas “continuous” refers to an ability to rotate around an axis without limits. The robot conceptualization as links and joints reflects the constructivism of robots' physical substance of being composed of parts.

The URDF uses a tree structure to describe a robot in the Extensible Markup Language (XML). A URDF-based RoboAvatar models the part-whole nature of robots via its link-and-joint system, and encodes a range of robot attributes to the joints or links. This has enabled applications such as kinematics and dynamic simulations, and production line design in robotics and manufacturing industry.

In Step S102, a given URDF file may be parsed so that its codified robot information can be retrieved or extracted. As the URDF file format is essentially an XML file, the parsing of URDF may be performed by reading the tags of different semantic meaning (e.g., <robot>, <link>, <joint>) and with different attributes (e.g., name and type of the <joint> tag). For robot mass and number of parts, since they are not explicitly expressed in URDF, they need to be extracted by adding up the mass and number of all links. For the remaining properties (e.g., the Productivity, and the Capability), they are specified as “None” since URDF does not offer such information.

The extracted robot information is used for the generation of a robot container and conversion (or translation) of links and joints in Steps S104 and S106. The robot container generated in Step S104 is basically a bucket to be filled with the converted (or translated) links and joints. The robot container may be modelled by IfcElementAssembly in IFC that has no explicit visual representation and placement. Therefore, the primary work is to simply convert the extracted robot properties.

After a robot container is created, the links and joints are translated to IFC representations in Step 106. Substance entities of the links and joints (i.e., IfcBuildingElementProxy and IfcVirtualElement) are first created. Then properties of the elements extracted from URDF are converted and represented in IFC.

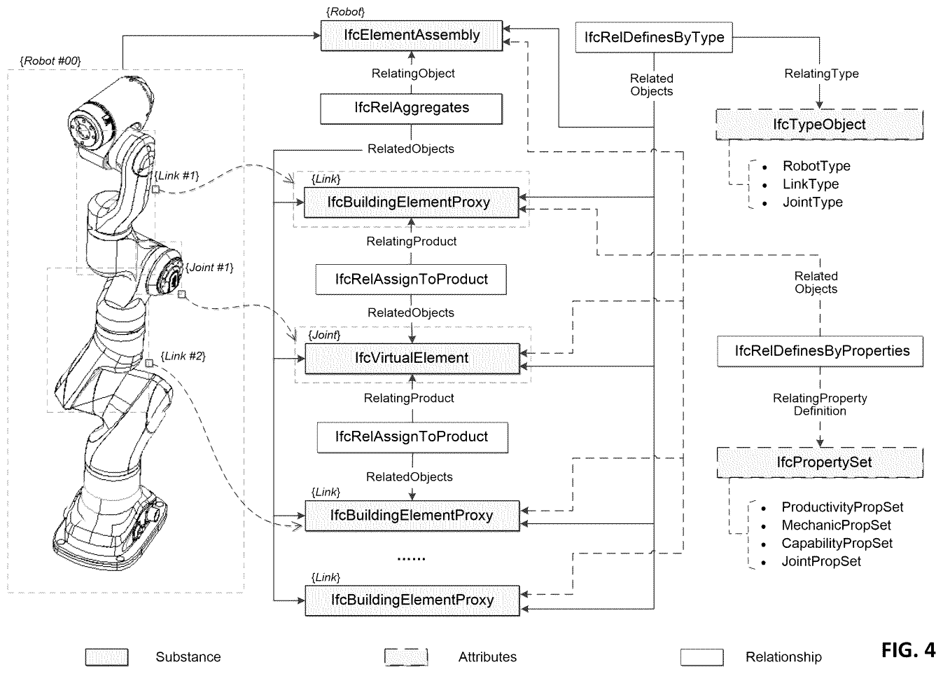

FIG. 4 shows the involved IFC entities and how they are connected to form the RoboAvatar. IFC follows a principle of seeing an entity composed by its substance (via IfcObject) and the manifested properties (via IfcProperty), plus a relation to connect them (via IfcRelationship). The substance of a robot is made up of parts that are connected sequentially. By referring to the URDF-based representation, it is decided to represent the robot substance in IFC by three types of objects, i.e., the Robot, the Link, and the Joint.

Robot, as a whole, is the assembly of parts. While it demonstrates certain unique properties that cannot be described by individual parts, it does not have explicit geometry but rather is collectively formed by the parts' geometric representations. A suitable IFC entity to model the Robot would be IfcElementAssembly. The IfcRelAggregates is used to connect the robot assembly with its parts.

Link is a physical non-deformable part of the robot. IFC offers several alternative approaches to representing links, e.g., IfcElementComponent, IfcDistributionElement, and IfcBuildingElementProxy. Table 2 compares the three entities, which indicates an absence of existing entity that can perfectly reflect a link's nature. Comparatively, given the extendibility of IfcBuildingElementProxy, it might be the most suitable for link representation.

TABLE 2
Comparison of IFC entities for robot link representation.

| IFC Entities | Advantages | Disadvantages | Suitability |
|---|---|---|---|
| IfcElementComponent | Appear to reflect the | Served as minor items connecting | X |
| | nature of links as being | major building elements, e.g., | |
| | parts of a wholistic | IfcFastener, which cannot reflect the | |
| | element | importance of the links themselves | |
| | | as major elements of a robot | |
| IfcDistributionElement | Some of its subtypes | Used for elements of a distribution | XX |
| | (IfcActuator, IfcSensor, | system, e.g., the ventilation, | |
| | etc.) are suitable for | plumbing, and heating, which is not | |
| | link components with | the case for individual robots | |
| | Sensory capability | | |
| IfcBuildingElementProxy | Not having a | A subtype of IfcBuildingElement, | XXX |
| | predefined semantic | implying a link is a building | |
| | meaning, and openness | element. | |
| | to future extension that | | |
| | will specify links to | | |
| | designated built-in | | |
| | entities | | |

Joint is an abstract element connecting different links. This characteristic can be well represented by the IfcVitualElement entity, which is usually used to provide imaginary boundaries between elements. The IfcRelAssignToProduct is used to assign links that a joint connects. To indicate the connection sequence, it is mandatory that a joint is assigned to its parent link, whereas it is the object to which its child link is assigned, as illustrated by FIG. 4.

The attributes of a robot and its parts are defined by IfcPropertySet and then assigned to corresponding objects via the IfcDefinesByProperties. It should be noted that some attributes in Table 1 have already been implicitly described in the above IFC-modeled robot substance. For example, the Connectedness (Tₑₙ) and Sequence (Tₛ) of the Topology attributes are readily codified into the joint-link relationship specified by IfcRelAssignToProduct. As for Geometry attributes, they have been specified when creating the link entities via the IfcObjectPlacement and IfcProductRepresentation. Only attributes other than the implicitly specified ones will be added. Table 3 summarizes information of the newly added properties.

TABLE 3
Information summary of the newly added robot properties.

| Name | Substance * | IfcProperty type | IfcProperty attributes |
|---|---|---|---|
| ThroughPut | R | IfcPropertySingleValue | Assigned as text description |
| SuccessRate | R | | |
| NaviSpeed | R | | |
| BatteryLimit | R | | |
| Mass | R&L | | |
| NumOfParts | R | | |
| Sensing | R&L | IfcPropertySingleValue | Boolean value of being either “TRUE of |
| Grasping | R&L | | FALSE” |
| Climbing | R&L | | |
| PickAndPlace | R&L | | |
| Locomotion | R | IfcPropertyEnumeratedValue | Defined as one of the following: [“Wheel”, |
| | | | “Leg”, “WheelLeg”, “Fly”] |
| JointMovType | J | IfcPropertyEnumeratedValue | Defined as one of the following: |
| | | | [“revolute”, “continuous”, “prismatic”, |
| | | | “fixed”, “floating”, and “planar”] |
| InertiaMat | L | IfcPropertyListValue | Represented as “[ixx, ixy, ixz, iyy, iyz, izz]” |
| JointMovAxis | J | IfcPropertyListValue | Normalized [x, y, z] representing axis of |
| | | | rotation or translation, or surface normal |
| JointMovLimit | J | IfcPropertyListValue | Represented as [Lower, Uppper], which is |
| | | | only applied to revolute and prismatic joints |

* Types of the substance, where R, L and J represent robot, links, and joints, respectively.

Each time a new link or joint is successfully converted, it needs to be added to the robot container. Special attention should be paid to a) generation of visual representation for the links, and b) specification of placement for both the links and joints, which are elaborated as in the following.

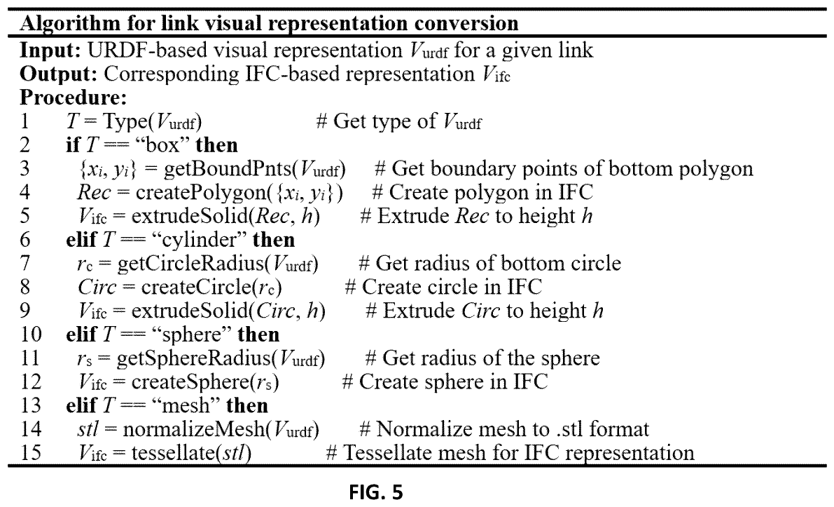

The pseudo code in FIG. 5 illustrates how to convert the URDF visual representation of a link V_{urdf} to a IFC representation V_{ifc}. There are four main types of visual representations in URDF, that is, the “box”, “cylinder”, “sphere”, “mesh”. Depending on the V_{urdf} type, different strategies will be used for the conversion. If the V_{urdf} is of a “box” type (indicated by a <box> tag in URDF), its geometry is specified by length, width and height of the box. With the three parameters, a replica of the box can then be generated in IFC. A similar principle is adopted for “cylinder” type, of which, however, the bottom close surface is a circle determined by its radius. When the V_{urdf} is a “sphere”, a IfcSphere element can be created based on the sphere radius to represent the corresponding V_{ifc}. The trickiest case is when the V_{urdf} is a “mesh” model of irregular shape. A range of formats might have been used to represent the mesh model, e.g., .stl, .dae, and .obj. Therefore, we first normalize the different mesh models to the .stl format using aspose-3d package, and then load the model uniformly via read_stl_file method of the OCC library. The parsed .stl file is further tessellated to be represented as Tessellation in IFC. It is worth noting that some links might not have visual representations.

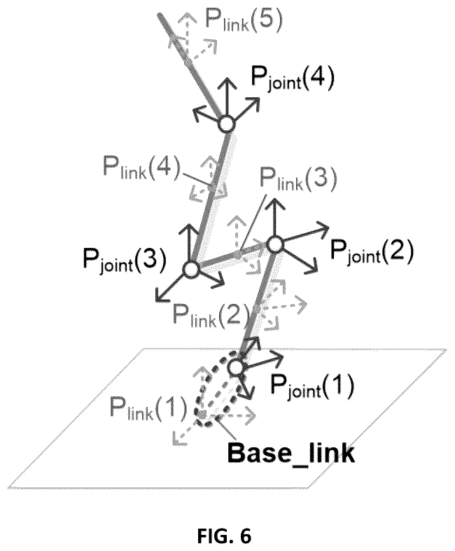

Placement specification articulates where and in what posture a link/joint is put. Both URDF and IFC adopt similar local placement principles in specifying object pose. As shown in FIG. 6, a joint's placement is specified by referring to the coordinate frame of its prior joint, while the first joint's placement is assigned relative to the first link of the robot, which is usually a nominal link with no visual representation. With the placement of joints in place, the links' pose can then be specified relative to corresponding prior joints. This recurrent process is mathematically expressed as follows:

$${P}_{joint} ( n ) = \{ \begin{matrix}{pose}_{joint} ( 1 ) ⊥ {P}_{link} ( 1 ) , n = 1 \\ {pose}_{joint} ( n ) ⊥ {P}_{joint} ( n - 1 ) , n > 1\end{matrix} \qquad ( 4 )$$

$${P}_{link} ( n + 1 ) = {pose}_{link} ( n + 1 ) ⊥ {P}_{joint} ( n ) , ( n \geq 1 ) \qquad ( 5 )$$

Where pose ⊥P represents the position and posture of an object specified by pose in a reference frame determined by P.

Different from URDF's leverage of Euler rotations (i.e., roll α, pitch β and yaw γ) to represent posture, IFC uses normalized directional vectors of an object's Z and X axes (i.e., dir_{Z} and dir_{X}) to represent its orientation. Mathematical formulas for the conversion can be expressed by:

$$\{ \begin{matrix}{dir}_{Z} = ( x , y , z ) \\ x = cos α sin β cos γ + sin α sin γ \\ y = cos α sin β sin γ - sin α cos γ \\ z = cos α cos β\end{matrix} \qquad ( 6 )$$

$${dir}_{X} = ( cos β cos γ , cos β sin γ , - sin β ) \qquad ( 7 )$$

To evaluate the effectiveness of the schema mediation method provided by the present invention, an IFC-based representation of robot, RoboAvatar, is evaluated with respect to modelling aspects as outlined in FIG. 2. To ensure comprehensiveness, heterogeneous types of robots have been used for the evaluation, including a low-cost wheel-driven mobile robot (TurtleBot3 Burger), a self-balancing wheeled-leg robot (Direct Drive Diablo), and a collaborative robot arm (UR-5e).

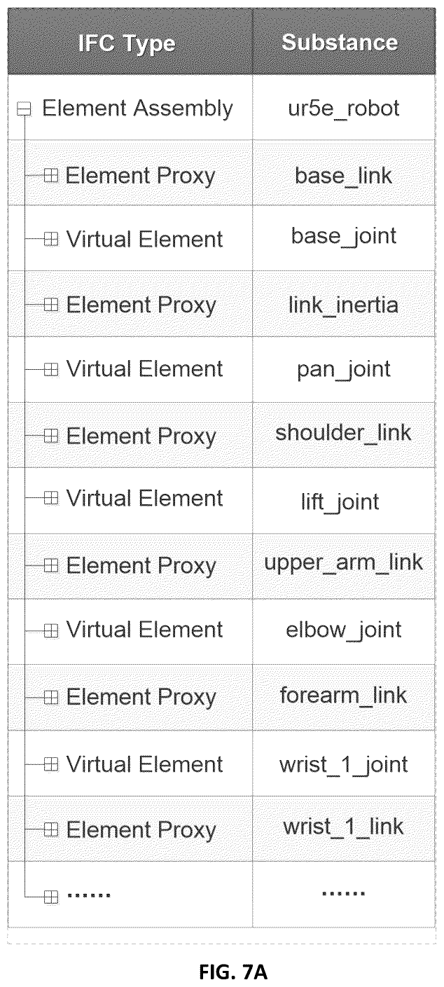

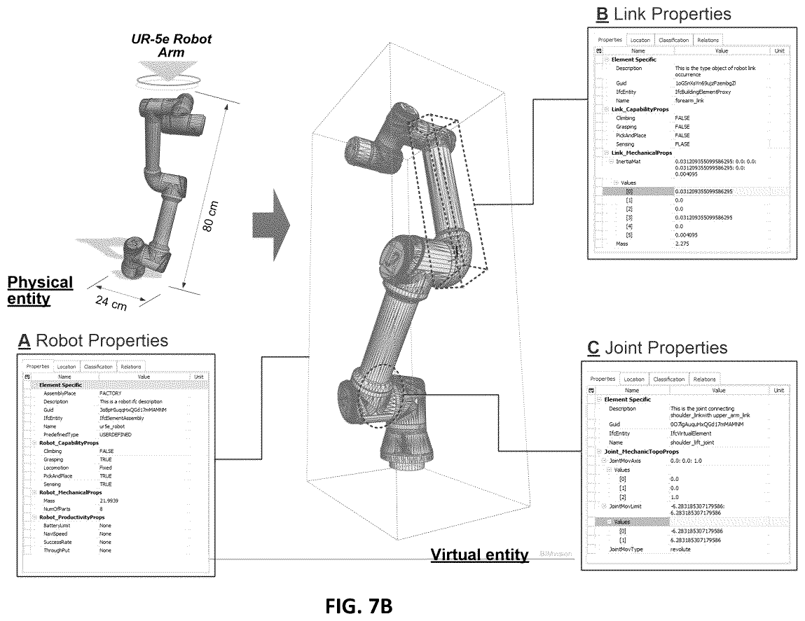

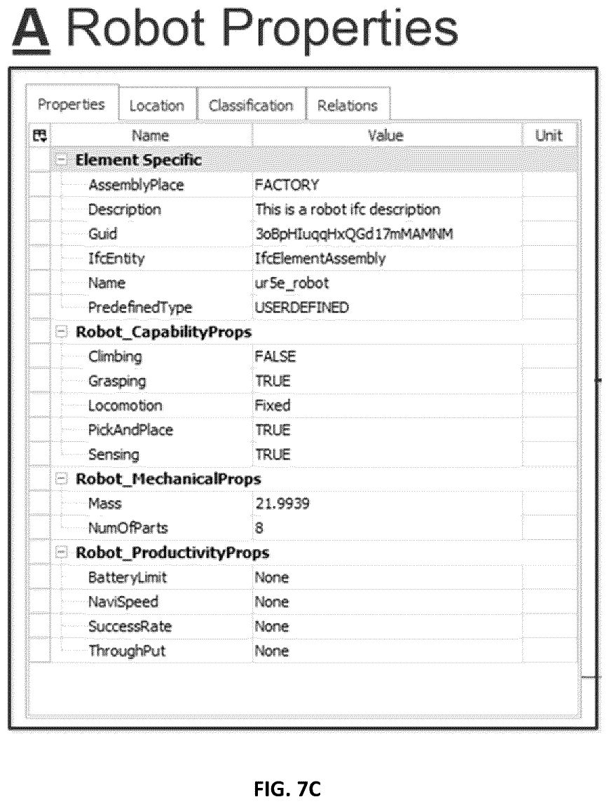

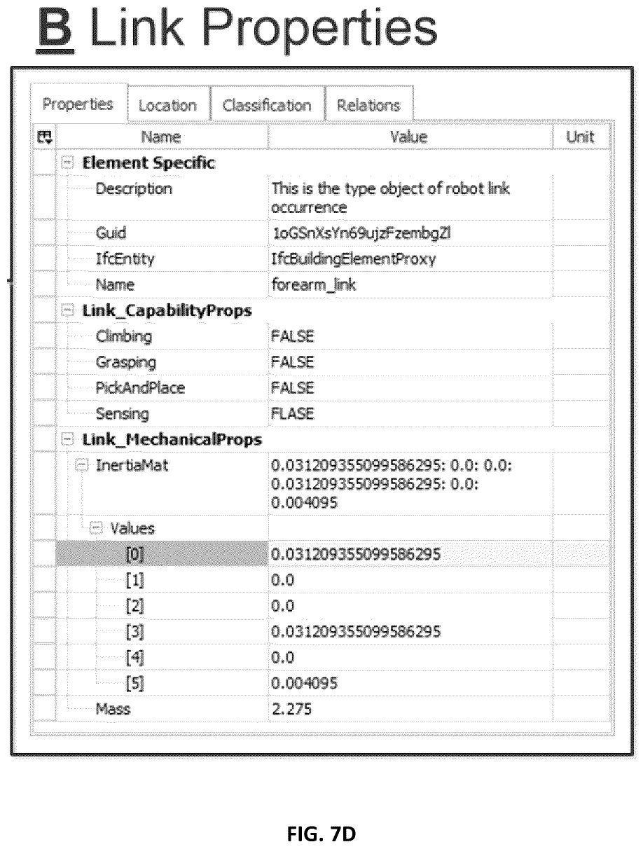

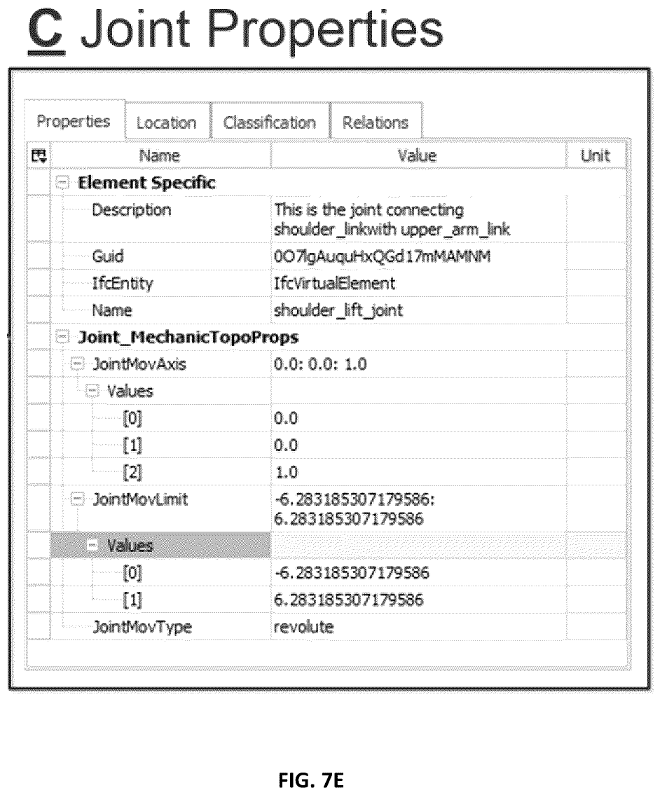

FIGS. 7A to 7E show the obtained Building RoboAvatar of UR-5e substantiated by IFC, which is visualized in an IFC model viewer (e.g., BIMvision). The IFC representation has successfully replicated the “whole-part” structure of the robot arm. This is evident by the tree structure in FIG. 7A, where the robot parts (links) are represented by IfcBuildingElementProxy, and connected by IfcVirtualElement-represented joints. All the links and joints have been combined to form the robot assembly. Geometry, topology, and other properties have also been effectively modeled, as shown in FIG. 7B. From a geometrical and topological standpoint, the IFC representation visually mimics its physical counterpart, which is displayed on the upper-left part of FIG. 7B. As for other properties (e.g., productivity, capability, and mechanics), they have been digitally represented and correlated to corresponding components as well.

The IFC Building RoboAvatars of three drastically different robots are developed and compared to those based on URDF. The evaluation is conducted from two aspects, that is, (a) the ability to represent the “whole-part” nature of the robot substance, and (b) the ability to describe the various sets of robot attributes. Table 4 presents a summary of the evaluation results. It is found both IFC and URDF can properly model the “Whole-Part” nature of robot substance, despite the variation of specific models, be it mobile robots like TurtleBot3 and Diablo, or fixed robot arms like UR-5e. However, deviations are observed when it comes to the ability to attribute description in Table 1.

As shown by Table 4, the IFC-based RoboAvatar can consistently represent the five aspects of attributes across different robot models, whereas traditional URDF schema falls short of describing properties on productivity and capability. For example, the IFC representation has successfully encoded productivity properties (e.g., BatteryLimit=28.9 Wh and NaviSpeed=0.22 m/s) and capabilities (e.g., Climbing=“False” and Locomotion=“Wheel”) of the TurtleBot3, which are not available in the URDF schema. The inclusion of these properties is of significant value for AECO activities. Considering the scenarios of facility inspection using robots. With a knowledge on the robot's navigation speed and battery limit, different inspection plans can be better simulated and evaluated in a more accurate manner. The results demonstrate the effectiveness of the proposed IFC RoboAvatar in digitally representing robot information needed for applications in built environment.

TABLE 4
Comparison between the URDF and
IFC-based robot representation.

| | | Substance | Attributes * | | | | |
|---|---|---|---|---|---|---|---|
| | | Whole- | P- | M- | T- | C- | G- |
| Robot | Schema | part | prop | prop | prop | prop | prop |
| TurtleBot3 | URDF | Y | N | Y | Y | N | Y |
| | IFC | Y | Y | Y | Y | Y | Y |
| Diablo | URDF | Y | N | Y | Y | N | Y |
| | IFC | Y | Y | Y | Y | Y | Y |
| UR-5e | URDF | Y | N | Y | Y | N | Y |
| | IFC | Y | Y | Y | Y | Y | Y |

* P-, M-, T-, C-, and G-prop refer to Productivity, Mechanical, Topology, Capability, and Geometry properties, respectively.

Performance of the computer-implemented method S100, denoted as RobIFCTrans translator, is evaluated. The conversion performance is measured from three aspects, i.e., accuracy, time, and storage. In particular, the accuracy focuses on evaluating whether the translator can correctly convert the visual presentation, structure, and core properties of the robots. A four-level grading system is established, where the number of “X” reflects how many aspects the translator has correctly converted, as shown in Table 5.

TABLE 5
The established four-level grading system
for translation accuracy evaluation.

| Symbol | Meaning * |
|---|---|
| O | None aspect in [Visual, Structure, |
| | Property] has been correctly converted. |
| X | One aspect in [Visual, Structure, |
| | Property] has been correctly converted. |
| XX | Two aspects in [Visual, Structure, |
| | Property] have been correctly converted. |
| XXX | Three aspects in [Visual, Structure, |
| | Property] have been correctly converted. |

* A correct translation means zero-tolerance of error in the respective aspect (e.g., If the “Property” aspect is rated correct, it means all properties of a robot have been correctly translated).

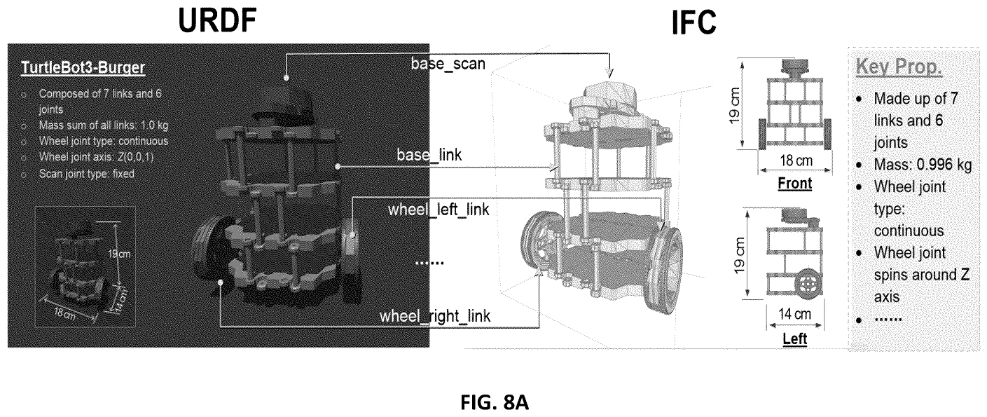

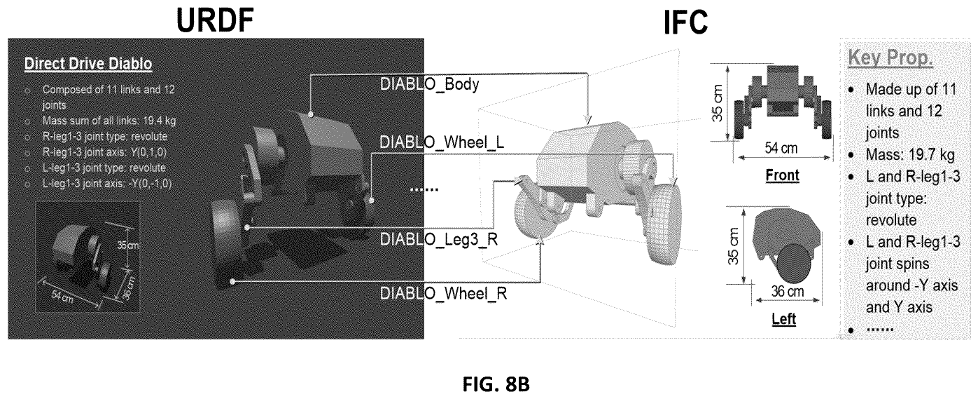

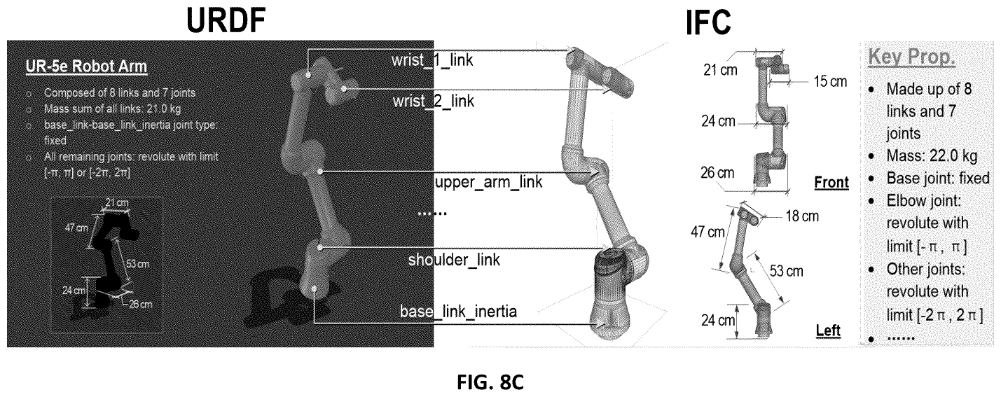

FIGS. 8A to 8C show resulting IFC representations for different robot types respectively, which indicate a solid translation accuracy. The translator has successfully resulted in IFC geometric representations identical to those of the URDF-based robot description. In fact, the two representations not only visually mimic each other, but also have the same geometry and scale, as evident by the identical annotations of typical dimensions in both the URDF and IFC representations. To indicate accuracy in translating the robot structure, A series of arrows are used to connect the corresponding robot components in the URDF and the resulting IFC representations. The translator correctly processed and converted all the robot components (including links and joints). For example, the Direct Drive Diablo has the most complicated structure, with a total of 11 links and 12 joints described in the original URDF file. After translation, the same structure has been reserved, where the IFC-based Diablo representation is made up of 11 links (represented by IfcBuildingElementProxy) and 12 joints (represented by IfcVirtualElement) as well. There are also some key properties listed in FIGS. 8A to 8C for a direct comparison. All the properties have remained unchanged after converting to IFC, e.g., the mass, joint types, their rotating axis and moving limits. The results demonstrate the highest level of translation accuracy, where all the three aspects of visual representation, structure, and core properties have been correctly translated.

We have conducted a series of test of applying the RobIFCTrans translator on six robots. The robots have significant variations in their types, geometric appearance, and locomotion mechanisms, which can ensure the comprehensiveness and objectiveness of the evaluation. Table 6 summarizes performance of the RobIFCTrans translator in terms of accuracy, time, and storage. As discussed above, the translator performed consistently in ensuring the conversion accuracy, irrespective of the robot types involved. When it comes to efficiency, the processing time is observed to be proportional to the size of the robot's URDF representation. It records the longest time consumption (71.9 s) when translating the UR-5e, which has a model size of 6.1 MB. A closer analysis of the translation process revealed that a significant proportion of the time consumption is allocated to tessellating the mesh geometric representations of the robots. For example, of the 71.9 s consumed in UR-5e translation, up to 68.8 s was spent on the mesh tessellation. To a certain extent, the translation is found to be storage-intensive. It significantly expands the size of the robot representation, as can be exemplified by the TurtleBot3, which requires nearly 8 times of original space to store the resulting IFC file. The storage intensiveness can be related to the redundant nature of IFC.

TABLE 6
Performance evaluation of the URDF-to-IFC translator.

| | URDF Size | Conversion performance | | |
|---|---|---|---|---|
| Robot | (MB) | Accuracy | Time (s) | Storage (MB) |
| TurtleBot3 | 4.6 | 3/3 | 50.6 | 32.6 |
| Diablo | 0.2 | 3/3 | 3.4 | 3.1 |
| UR-5e | 6.1 | 3/3 | 71.9 | 45.8 |
| Fetch | 3.8 | 3/3 | 36.3 | 27.9 |
| Crawler | 0.3 | 3/3 | 0.3 | 0.1 |
| Da Vinci | 3.6 | 3/3 | 18.5 | 15.5 |
| Average | 3.1 | 3/3 | 30.2 | 20.8 |

### Use Cases of Building Robavatar

### Robot-Oriented Indoor Space Design

The IFC-based Building RoboAvatar can be seamlessly integrated into existing BIM-based design workflow, making it possible to consider at early stage how the building design should be adapted to the use of construction robots. An example of wall painting robot is leveraged to illustrate the use case. The wall painting robot is a UR-5e installed on a mobile platform. It has the capability of moving on flat surface via its “Wheel” locomotion ability. The dimensions of the mobile platform are 1.0 m×0.9 m×0.8 m, and the reach of the UR-5e robot arm is 0.9 m

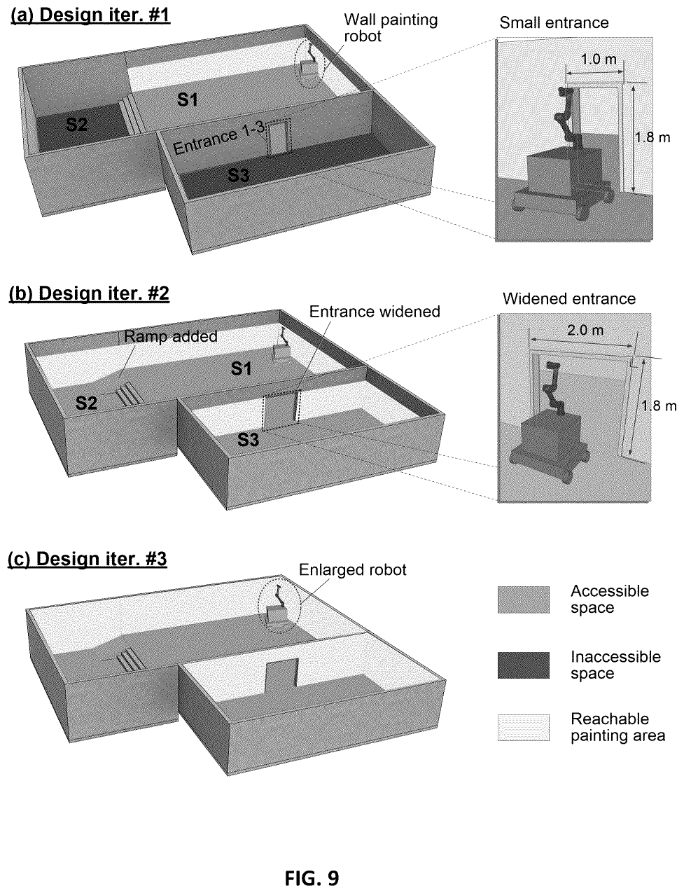

FIG. 9A shows the initial design of an indoor space, which will be painted by the above wall painting robot. The color-coded map indicates accessibility and reachability of the robot, showing that a large proportion of the space (i.e., S2 and S3) cannot be accessed by the robot. For example, S2 cannot be accessed by the robot for its incapability to navigate across the stairs connecting S1 and S2. As for S3, entrance #1-3 is too narrow to allow the robot get through, as illustrated by the subplot in FIG. 9A. The direct incorporation of the painting robot has allowed an adaption of the initial design to meet the need of robotic construction. As shown in FIG. 9B, a widening of entrance #1-3 has made S3 accessible by the robot. At the meantime, a ramp was added to one side of the stairs, which can ensure accessibility of S2 by the robot.

While all the space can now be accessed, it can be observed from FIG. 9B that upper ends of the walls cannot be painted by the robot. This is because the reach of the robot arm can only allow a painting height of up to 1.7 m (robot arm reach 0.9 m plus the platform height 0.8 m). Obviously, it is not practical to lower the entire floor height to ensure a full painting coverage. A commendable solution is therefore to adjust the design of the robot. For example, the mobile platform can be elevated from the current 0.8 m to 1.3 m, and at the meantime, the robot arm should be replaced by one with larger reach (e.g., UR-10e with a reach of 1.3 m). This will increase the coverage of the painting to up to 2.6 m. In this case, all the walls in the space can be properly covered, as shown in FIG. 9C.

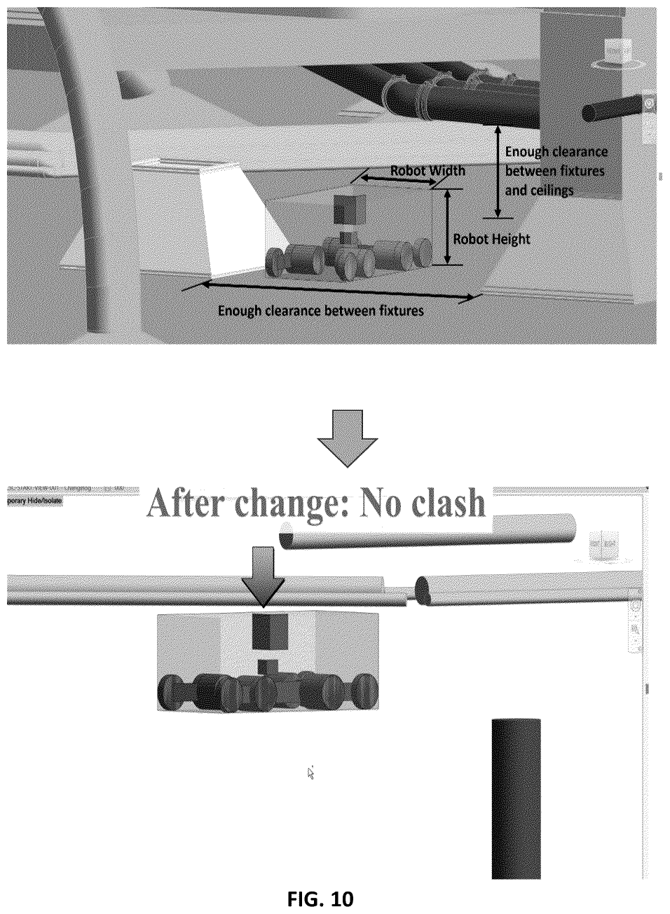

FIG. 10 shows an integrated design example of a MEP (Mechanical, electrical, and plumbing) inspection robot. False ceilings are usually used to store, hide, and protect necessary building utility (e.g., MEP systems). It is necessary to inspect and maintain false ceilings routinely to avoid health and safety hazards such as water accumulation, corrosion and pest infestations. Existing false ceiling maintenance procedures are labor-intensive and can be both cumbersome and dangerous due to poor lighting conditions, limited inspection space, and numerous obstacles. Robots have the potential to help people with inspection tasks, but robot-incompatible false ceiling designs often weaken their performance. With our IFC-based representation of the inspection robot, we can directly import the robot model into Revit, a BIM design software. It enables us to implement integrated design easily, with details elaborated as follows:

To inspect false ceilings thoroughly, the robot must traverse into the intricate piping to observe objects of interest and detect defects. With both robot and MEP model opened in the same software environment, Dynamo for Revit is used to retrieve model information (e.g., robot height, MEP clearance, etc.) and check for clashes. Taking a hospital project as an example, the clearance between the fixture and the ceiling panel is first found and then compared with the robot's bounding box. As a result, the positions of 694 pipes are detected that require adjustment. According to the above checks, some suggestions are given to designers: (i) The 694 detected pipes on the fourth floor can be moved to a higher position to provide larger clearance; (ii) rearranging the positions of MEP systems can reduce visual obstacles thus expanding the effective field of view of the robot.

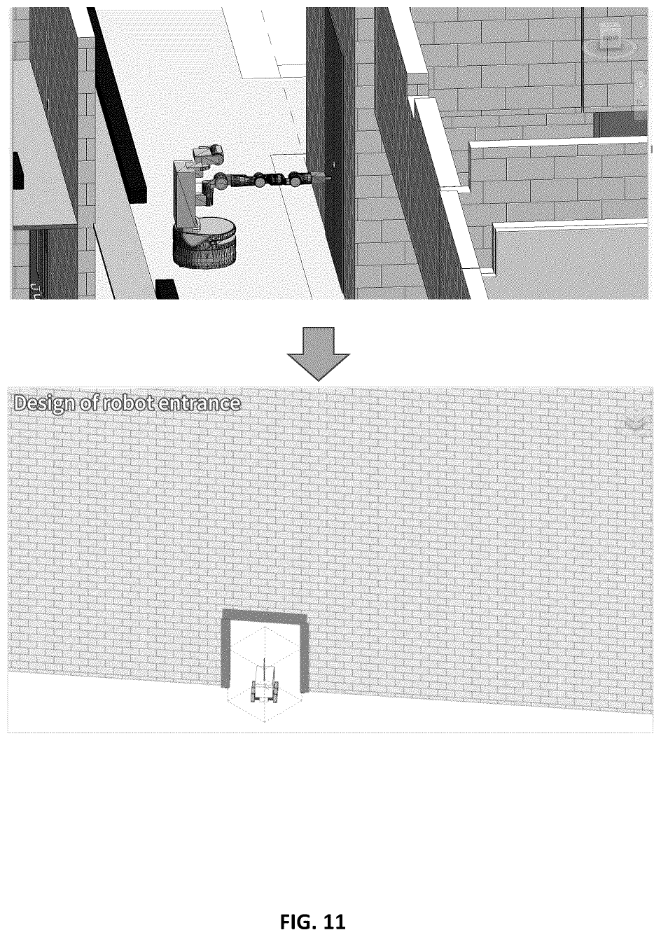

FIG. 11 shows another robot-inclusive design example enabled by our IFC robot representation. It is based on a case of intra-hospital delivery robots. It is necessary to allow the robots to reach as many rooms as possible to serve more people. Thanks to our invention, a model of the delivery robot and BIM of the project can be integrated into the same design environment based on Revit. In Dynamo for Revit, the designer generated the robot's bounding box based on the RoboAvatar and compared it with the dimensions of the door to perform a dimensional compatibility check, as shown in FIG. 11. Doors that are not compatible with the robot's dimensions will be warned and marked red. The designer needs to consider the room's function and the robot's function to decide whether the door needs to be enlarged or not.

The example above demonstrates how the Building RoboAvatar can facilitate a co-adaption of building and robot design to allow smooth adoption of robotics in construction. Surely, it is a hypothetical scenario with simplification. Since real-life design is always a trade-off among multiple objectives under a set of constraints, it might be too idealistic to imagine drastic design changes simply for accommodating the use of robots. Nevertheless, the case shows the promise of our Building RoboAvatar in facilitating designers to consider robot as an additional design factor.

### Digital Twin Facility Management Robot

Another use case of Building RoboAvatar is high-fidelity digital twinning of facility management robots. As digital replicas reflecting real-time status of the physical robots, digital twin is deemed a promising way to effectively plan out facility management conducted by robots. However, tremendous efforts are needed to develop Avatar of the robots compatible with existing IFC-based built environment representations. This either leads to significant workload to reprogram existing robot description to an IFC-based RoboAvatar, or results in low-grain simplified representations (e.g., denoting robot by a box or a dot).

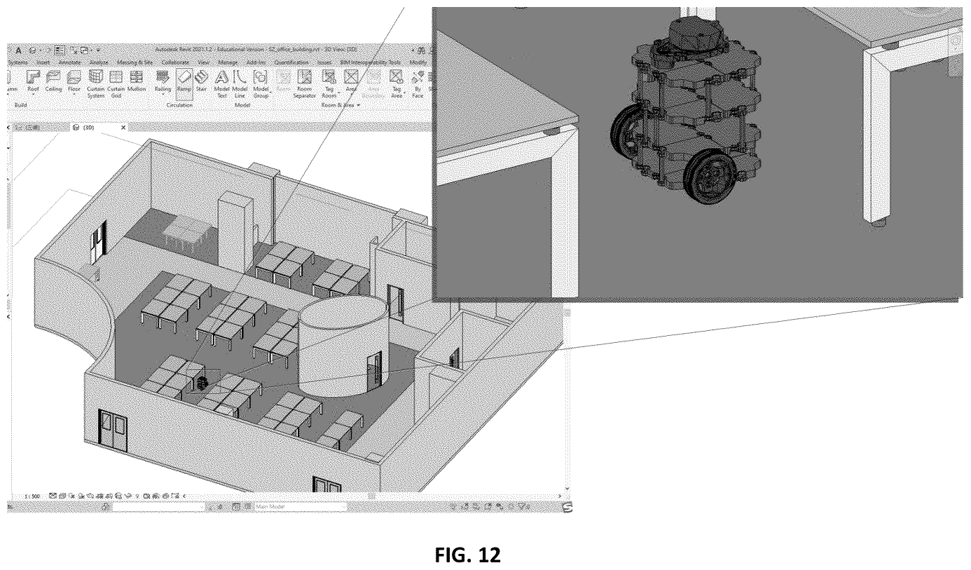

The IFC-based Building RoboAvatar presents a scalable way to generate compatible and high-fidelity robot digital twin. Take a TurtleBot3 used for facility inspection as an example. Users can simply convert its readily available URDF representation to an undistorted IFC-based Avatar with our translator, which will be compatible mainstream BIM software, e.g., Revit and BIM 360 by Autodesk. FIG. 12 shows IFC avatar of the TurtleBot in Revit model of an office space. All the details of the robot (e.g., its constituent components, and corresponding mechanical properties) are reserved in the IFC Avatar. It is then straightforward to twin movements of the physical robot to its Avatar for intuitive monitoring during facility inspection.

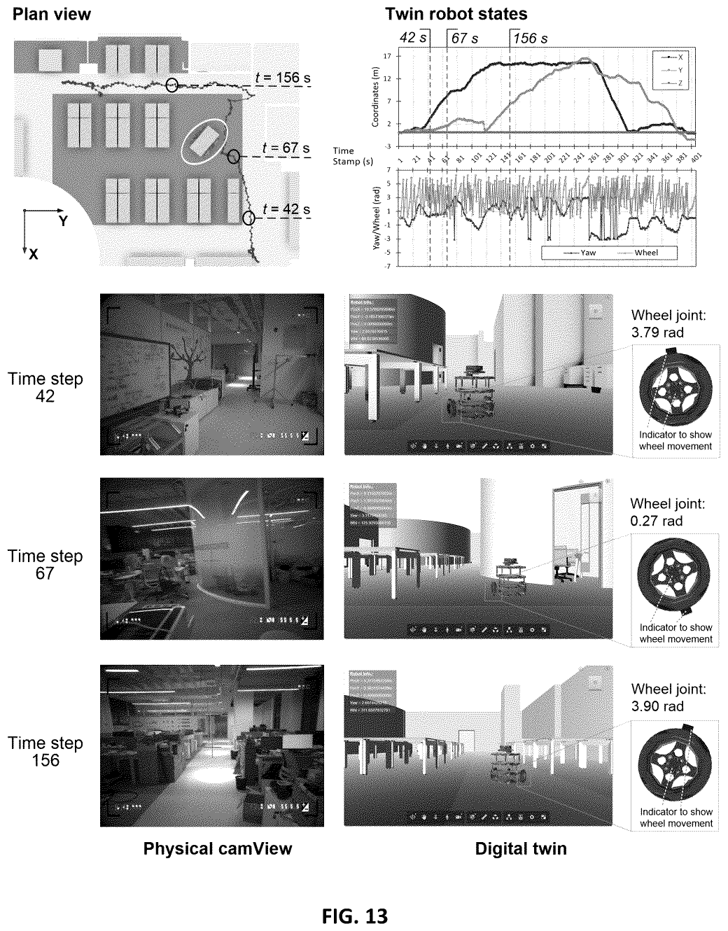

FIG. 13 presents digital twinning results of a TurtleBot that is inspecting an office facility. As the robot navigates in the office, video of its surrounding is recorded for visual inspection. The robot status including position (i.e., x, y, and z) and posture (i.e., the robot's yaw angle, and rotating angle of the robot wheels) was monitored and sent to a remote server. The digital twin based on the IFC digital robot representation retrieved robot status data from the server in a regular basis. The retrieved information is used to animate the corresponding joints of the robot digital twin. For example, if the robot's left wheel rotates by 0.5 rad, then its digital counterpart will revolve around the central joint by the same degree of angle. The line plots on the upper-right corner of FIG. 13 show the recorded data throughout the entire inspection process. The IFC RoboAvatar was animated according to the real-time captured data, which form a digital twin of the physical robot. The diagram on the upper-left corner of FIG. 13 is a top-down plan view showing the robot's moving trajectory, where three timestamps are highlighted with circles. The streamed video captured by the physical camera and the corresponding digital twin are also shown in FIG. 13.

It can be observed that the resulted digital twin is of great granularity, which can not only use a realistic geometric Avatar to indicate the robot movement, but also captures nuanced kinematic motion of its components. This is evident by the changing position of the blue cubic relative to the red cubic at the wheel center on the right side of FIG. 13, which were added to indicate the wheel movements. A screen record footage can be found online: https://youtu.be/EHvGLBLpf4U. The high-fidelity digital twin opens new possibilities of kinematic or dynamic simulation of FM robots in BIM environment.

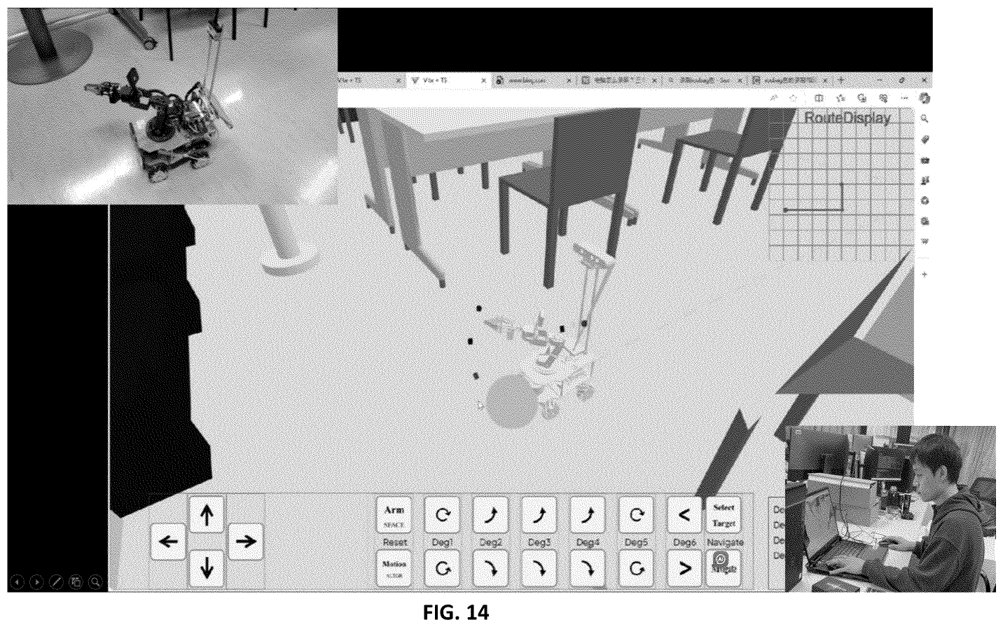

FIG. 14 shows an example of how to leverage the integration enabled by IFC RoboAvatar to remote control a robot. In this web portal, we have applied our invention to integrate a robot and a building model. As the environment information is readily available, if the robot is required to do certain tasks (e.g., move to a certain point), one can simply click the target position in this model. And then the system can automatically use the building information to plan the robot movement.

### Building RoboAvatar as a Way Towards Interoperability in Construction Robotics

With increasing prevalence of construction robotics, the issue of interoperability emerges, where data schemas used to represent robots and the built environment are mutually incompatible. This has induced limitations and additional costs in the adoption of robotics in construction). Such interoperability dilemma is not new, but occurs every now and then when disruptive digital technologies are introduced to the AECO industry, as observed in the efforts to integrate BIM with the geographic information system (GIS). When such dilemma takes places, an interface is needed to facilitate interoperability.

By laying out information needed to represent a robot in a building context, the Building RoboAvatar has potential to serve as an interface to bridge the robotics and AECO sector.

First, the Building RoboAvatar is considerately defined by taking into account both the need of building and the fundamental structures of robots. Two aspects of properties, i.e., the Productivity and the Capability, have been introduced that are of interests by AECO professionals. The former characterizes parameters that are highly relevant to the productivity of robots in executing construction tasks, e.g., throughput and success rate, which are critically important for overall project planning and scheduling. The capability properties, on the other hand, define what a particular robot is capable of, e.g., climbing and grasping. This information is helpful in task-level planning or assignment. Other than high-level properties, our Building RoboAvatars have inherited mainstream description manners in existing robot representations. This deliberate design of the Building RoboAvatar to transcend both robotics and AECO gives it a unique opportunity to bridge the two areas.

Second, the Building RoboAvatar has been substantiated with the de facto common language of the AECO industry, IFC. Without proper substantiation, no matter how well the RoboAvatar is defined, it will not exert too much impact in implementation. This is particularly the case in the construction industry, where a profusion of proprietary design and project management software programs are used. We select IFC, a widely accepted vendor-neutral data schema for built asset information description, to instantiate the Building RoboAvatar. Entities in the IFC schema are carefully examined and compared to determine suitable model view definition to substantiate the RoboAvatar. The IFC-based representation ensures the compatibility with mainstream AECO software and workflow that are largely based on BIM.

Third, a translator for URDF-to-IFC conversion is developed, which provides a tool to directly make use of the many readily available RoboAvatars. Different from existing attempts to convert IFC built environment representations to URDF, our RobIFCTrans translator will foster a building-centric view to look at the adoption of robotics. It offers a new pathway to achieve robot-oriented design. By turning existing URDF RoboAvatars into IFC representations, our approaches can enable direct integration of robot information into existing BIM-based design workflow. It will then materialize the robot-oriented design philosophy into something implementable in existing design tools, enabling AECO professionals to explore how building designs can be adapted to accommodate the introduction of robots.

The functional units and modules of the [apparatuses, devices, systems, compounds, materials, and/or methods] in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. A computer-implemented method for mediating a robot-centric data schema to a building-centric data schema for representing a robot, wherein the building-centric data schema represents the robot with a plurality links representing non-deformable parts of the robot and a plurality of joints describing relationship between the links, the method comprising:
extracting robot information from the robot-centric data schema;
creating a robot container to model the robot as a whole-part structure;
translating the plurality of links and the plurality of joints from the robot-centric data schema to the building-centric data schema based on the extracted robot information;
filling the robot container with the translated links and translated joints; and
constructing the building-centric data schema with the robot container filled with the translated links and translated joints.

2. The computer-implemented method of claim 1, wherein extracting robot information from the robot-centric data schema comprises parsing the robot-centric data schema.

3. The computer-implemented method of claim 1, wherein extracting robot information from the robot-centric data schema comprises:
computing a total number of parts by counting all links; and
computing a robot mass by adding up the mass of all links.

4. The computer-implemented method of claim 1, wherein translating the plurality of links and the plurality of joints from the robot-centric data schema to the building-centric data schema comprises:
creating a corresponding link-type substance entity for each link;
specifying the corresponding link-type substance entity with link properties extracted from the robot-centric data schema;
creating a corresponding joint-type substance entity; and
specifying the corresponding joint-type substance entity with joint properties extracted from the robot-centric data schema.

5. The computer-implemented method of claim 4, wherein translating the plurality of links and the plurality of joints from the robot-centric data schema to the building-centric data schema further comprises generating a visual representation for each link.

6. The computer-implemented method of claim 5, wherein the visual representation is a box-type visual representation; and the corresponding link-type substance entity is specified by length, wide and height of the box-type visual representation.

7. The computer-implemented method of claim 5, wherein the visual representation is a cylinder-type visual representation; and the corresponding link-type substance entity is specified by radius of bottom surface and height of the cylinder-type visual representation.

8. The computer-implemented method of claim 5, wherein the visual representation is a sphere-type visual representation; and the corresponding link-type substance entity is specified by radius of the sphere-type visual representation.

9. The computer-implemented method of claim 5, wherein the visual representation is a mesh-type visual representation; and the corresponding link-type substance entity is specified by a mesh model of the mesh-type visual representation.

10. The computer-implemented method of claim 1, wherein translating the plurality of links and the plurality of joints from the robot-centric data schema to the building-centric data schema further comprises:
specifying placement of each link; and
specifying placement of each joint.

11. A computer-implemented system for mediating a robot-centric data schema to a building-centric data schema for representing a robot, wherein the robot-centric data schema represents the robot with a plurality links representing non-deformable parts of the robot and a plurality of joints describing relationship between the links, the system comprising a processor configured to:
extract robot information from the robot-centric data schema;
create a robot container to model the robot as a whole-part structure;
translate the plurality of links and the plurality of joints from the robot-centric data schema to the building-centric data schema based on the extracted robot information;
fill the robot container with the translated links and translated joints; and
construct the building-centric data schema with the robot container filled with the translated links and translated joints.

12. The computer-implemented system of claim 11, wherein the processor is further configured to extract the robot information from the robot-centric data schema by parsing the robot-centric data schema.

13. The computer-implemented system of claim 11, wherein the processor is further configured to extract the robot information from the robot-centric data schema by:
computing a total number of parts by counting all links; and
computing a robot mass by adding up the mass of all links.

14. The computer-implemented system of claim 11, wherein the processor is further configured to translate the plurality of links and the plurality of joints from the robot-centric data schema to the building-centric data schema by:
creating a corresponding link-type substance entity for each link;
specifying the corresponding link-type substance entity with link properties extracted from the robot-centric data schema;
creating a corresponding joint-type substance entity; and
specifying the corresponding joint-type substance entity with joint properties extracted from the robot-centric data schema.

15. The computer-implemented system of claim 14, wherein the processor is further configured to translate the plurality of links and the plurality of joints from the robot-centric data schema to the building-centric data schema by generating a visual representation for each link.

16. The computer-implemented system of claim 15, wherein the visual representation is a box-type visual representation; and the corresponding link-type substance entity is specified by length, wide and height of the box-type visual representation.

17. The computer-implemented system of claim 15, wherein the visual representation is a cylinder-type visual representation; and the corresponding link-type substance entity is specified by radius of bottom surface and height of the cylinder-type visual representation.

18. The computer-implemented system of claim 15, wherein the visual representation is a sphere-type visual representation; and the corresponding link-type substance entity is specified by radius of the sphere-type visual representation.

19. The computer-implemented system of claim 15, wherein the visual representation is a mesh-type visual representation; and the corresponding link-type substance entity is specified by a mesh model of the mesh-type visual representation.

20. The computer-implemented system of claim 11, wherein the processor is further configured to translate the plurality of links and the plurality of joints from the robot-centric data schema to the building-centric data schema by:
specifying placement of each link; and
specifying placement of each joint.
